(19) United States
(12) Patent Application Publication
(10) Pub. No.: US 2025/0247297 A1
(43) Pub. Date: Jul. 31, 2025

(54) Efficient Distribution of Cell Configurations in a Radio Access Network (RAN)

(71) Applicant: Telefonaktiebolaget LM Ericsson (publ), Stockholm (SE)

(72) Inventors: John Power, Athlone, County Westmeath (IE); Mathias Sintorn, Sollentuna (SE)

(21) Appl. No.: 18/851,334

(22) PCT Filed: May 27, 2022
(86) PCT No.: PCT/EP2022/064450

§ 371 Date: Sep. 26, 2024

(51) Int. Cl. H04L 41/0894; H04W 24/10; H04W 60/00

(52) U.S. Cl. CPC H04L 41/0894; H04W 24/10; H04W 60/00

(57) ABSTRACT

Embodiments include methods for a first network node configured to serve one or more cells in a radio access network (RAN). Such methods include detecting a neighbor cell for which the first network node does not store a configuration and obtaining, from a tracking node, an indication of one or more second network nodes that store the configuration for the neighbor cell. Such methods also include obtaining the configuration for the neighbor cell from one of the indicated second network nodes. Other embodiments include complementary methods for the tracking node, as well as network nodes configured to perform such methods.

### TECHNICAL FIELD

The present application relates generally to the field of communication networks, and more specifically to techniques for efficiently distributing configurations of cells served by radio access network (RAN) nodes to other (e.g., peer) RAN nodes that require such configurations.

### INTRODUCTION

At a high level, the 5G System (5GS) consists of an Access Network (AN) and a Core Network (CN). The AN provides UEs connectivity to the CN, e.g., via base stations such as gNBs or ng-eNBs described below. The CN includes a variety of Network Functions (NF) that provide a wide range of different functionalities such as session management, connection management, charging, authentication, etc.

FIG. 1 illustrates a high-level view of an exemplary 5G network architecture, consisting of a Next Generation Radio Access Network (NG-RAN) 199 and a 5G Core (5GC) 198. NG-RAN 199 can include one or more gNodeB's (gNBs) connected to the 5GC via one or more NG interfaces, such as gNBs 100, 150 connected via interfaces 102, 152, respectively. More specifically, gNBs 100, 150 can be connected to one or more Access and Mobility Management Functions (AMFs) in the 5GC 198 via respective NG-C interfaces. Similarly, gNBs 100, 150 can be connected to one or more User Plane Functions (UPFs) in 5GC 198 via respective NG-U interfaces. Various other network functions (NFs) can be included in the 5GC 198, as described in more detail below.

In addition, the gNBs can be connected to each other via one or more Xn interfaces, such as Xn interface 140 between gNBs 100 and 150. The radio technology for the NG-RAN is often referred to as “New Radio” (NR). With respect the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport. In some exemplary configurations, each gNB is connected to all 5GC nodes within an “AMF Region” with the term “AMF” referring to an access and mobility management function in the 5GC.

The NG RAN logical nodes shown in FIG. 1 include a Central Unit (CU or gNB-CU) and one or more Distributed Units (DU or gNB-DU). For example, gNB 100 includes gNB-CU 110 and gNB-DUs 120 and 130. CUs (e.g., gNB-CU 110) are logical nodes that host higher-layer protocols and perform various gNB functions such controlling the operation of DUs. A DU (e.g., gNB-DUs 120, 130) is a decentralized logical node that hosts lower layer protocols and can include, depending on the functional split option, various subsets of the gNB functions. As such, each of the CUs and DUs can include various circuitry needed to perform their respective functions, including processing circuitry, transceiver circuitry (e.g., for communication), and power supply circuitry.

A gNB-CU connects to one or more gNB-DUs over respective F1 logical interfaces, such as interfaces 122 and 132 shown in FIG. 1. However, a gNB-DU can be connected to only a single gNB-CU. The gNB-CU and connected gNB-DU(s) are only visible to other gNBs and the 5GC as a gNB. In other words, the F1 interface is not visible beyond gNB-CU.

FIG. 2 shows an exemplary protocol stack for the Xn signaling or control plane (CP) interface between gNBs, also referred to herein as “Xn-C protocol stack”. The RNL portion at the top is based on the XnAP protocol, while the TNL portion at the bottom is based on Stream Control Transmission Protocol (SCTP) and Internet Protocol (IP). These transport protocols are above implementation-specific data link and physical layers. Since SCTP is a point-to-point protocol, each gNB has a separate Xn interface to each of the neighboring gNBs that it communicates with.

As specified in 3GPP TS 38.423 (v16.7.0), XnAP protocol includes mobility procedures and global procedures. One of the global procedures is the Xn Setup procedure for establishing an Xn interface between two peer NG-RAN nodes (e.g., gNBs). In this procedure, one of the nodes sends an Xn Setup Request message that includes a complete (or partial, if supported) list of cells served by that node. The peer node responds with an Xn Setup Response message that a complete (or partial, if supported) list of cells served by the peer node.

Another Xn global procedure is configuration update, whereby NG-RAN nodes (e.g., gNBs) can inform each other about updates to the configurations provided during Xn interface establishment. Such updates can include information about addition, deletion, and/or modification of served (i.e., own) NR cells, neighboring NR cells served by neighbor gNBs, and neighboring LTE cells served by base stations (called eNBs) in LTE E-UTRAN.

### SUMMARY

In some scenarios, multiple gNBs can cover the same area. For example, a macro gNB can serve a large number of cells that cover a large geographic area, and a micro gNB can serve a much smaller number of cells that cover a small geographic area that overlaps with a portion of the large geographic area covered by the macro gNB. In other words, one (or some small number) of the macro gNB's cells overlaps with (or are adjacent to) the coverage area of the micro gNB's cells.

When the configuration of any of the macro gNB's cells changes, the macro gNB will initiate the Xn configuration update procedure towards the micro gNB. Assuming that a configuration change is equally likely for all macro gNB cells, this will create a lot of unnecessary signaling about macro gNB cells that are not relevant to the micro gNB coverage area. This can severely tax the more limited signaling, CPU, and memory resources of the micro gNB. More generally, this unnecessary signaling causes over-dimensioning of network signaling resources and excessive network energy consumption.

Embodiments of the present disclosure address these and other problems, issues, and/or difficulties, thereby facilitating more efficient signaling between nodes (e.g., base stations, gNBs, eNBs, etc.) in a RAN.

Some embodiments include exemplary methods (e.g., procedures) for a first network node configured to serve one or more cells in a RAN.

These exemplary methods can include detecting a neighbor cell for which the first network node does not store a configuration. These exemplary methods can also include obtaining, from a tracking node, an indication of one or more second network nodes that store the configuration for the neighbor cell. These exemplary methods can also include obtaining the configuration for the neighbor cell from one of the indicated second network nodes.

In some embodiments, the tracking node does not serve any cells in the RAN and/or does not store any configurations for any cells in the RAN. Rather, such operations are performed by RAN nodes, such as the first network node. In other embodiments, the tracking node is a network node that serves one or more cells in the RAN.

Other embodiments include exemplary methods (e.g., procedures) for a tracking node configured to track cell configurations for cells of a RAN.

These exemplary methods can include receiving, from a first network node, a cell configuration registration indicating that the first network node stores a configuration for a first cell in the RAN. These exemplary methods can also include registering an association between the first network node and the first cell in accordance with the cell configuration registration. These exemplary methods can also include subsequently receiving, from a second network node, a request for a list of network nodes that store the configuration for the first cell. These exemplary methods can also include, based on the registered association, sending to the second network node an indication that the first network node stores the configuration for the first cell.

In some embodiments, the tracking node does not serve any cells in the RAN and/or does not store any configurations for any cells in the RAN. Rather, such operations are performed by RAN nodes, such as the first network node. In other embodiments, the tracking node is a network node that serves one or more cells in the RAN.

Other embodiments include RAN nodes (e.g., base stations, eNBs, gNBs, ng-eNBs, etc.) and tracking nodes (e.g., base stations, eNBs, gNBs, ng-eNBs, NM/OAM/OSS/BSS nodes, host computing nodes, etc.) that are configured to perform the operations corresponding to any of the exemplary methods described herein. Other embodiments also include non-transitory, computer-readable media storing computer-executable instructions that, when executed by processing circuitry associated with such RAN nodes and tracking nodes, configure the same to perform operations corresponding to any of the exemplary methods described herein.

These and other disclosed embodiments can eliminate the need for a gNB to send configurations for all of its served cells to all peer gNBs, as well as the need to send configuration updates to all peer gNBs. This reduces and/or minimizes the amount of inter-node signaling for cell management, such as when cells are deactivated to reduce network energy consumption. Additionally, since a gNB can obtain a configuration for a newly found cell (e.g., reported by a UE in a measurement report) as needed, this reduces the amount of cell configuration information needing to be stored in gNB memory, thereby reducing cost and complexity. This can be particular advantageous for micro gNBs or other NG-RAN nodes requiring low complexity.

These and other objects, features, and advantages of the present disclosure will become apparent upon reading the following Detailed Description in view of the Drawings briefly described below.

### BRIEF DESCRIPTION OF THE DRAWINGS

FIG. 1 shows an exemplary 5G network architecture.

FIG. 2 shows an exemplary protocol stack for the Xn signaling interface between RAN nodes (e.g., gNBs).

FIG. 3 shows an exemplary Network Function Virtualisation Management and Orchestration (NFV-MANO) architectural framework for a 3GPP-specified network.

FIG. 4 shows an exemplary configuration update procedure via an Xn interface between nodes (e.g., gNBs) of an NG-RAN.

FIG. 5 shows an exemplary RAN comprising seven (7) gNBs that serve a plurality of cells in coverage area.

FIG. 6 shows a signaling diagram for an exemplary centralized cell configuration tracking architecture, according to some embodiments of the present disclosure.

FIG. 7 shows a signaling diagram for an exemplary decentralized or distributed cell configuration tracking architecture, according to other embodiments of the present disclosure.

FIG. 8 (which includes FIGS. 8A-B) shows an exemplary method (e.g., procedure) for a first network node configured to serve one or more cells in a RAN, according to various embodiments of the present disclosure.

FIG. 9 (which includes FIGS. 9A-B) shows an exemplary method (e.g., procedure) for a tracking node configured to track cell configurations for cells of a RAN, according to various embodiments of the present disclosure.

FIG. 10 shows a communication system according to various embodiments of the present disclosure.

FIG. 11 shows a UE according to various embodiments of the present disclosure.

FIG. 12 shows a network node according to various embodiments of the present disclosure.

FIG. 13 shows host computing system according to various embodiments of the present disclosure.

FIG. 14 is a block diagram of a virtualization environment in which functions implemented by some embodiments of the present disclosure may be virtualized.

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features and advantages of the disclosed embodiments will be apparent from the following description.

Furthermore, the following terms are used throughout the description given below:
Core Network Node: As used herein, a “core network node” is any type of node in a core network. Some examples of a core network node include, e.g., a Mobility Management Entity (MME), a serving gateway (SGW), a Packet Data Network Gateway (P-GW), etc. A core network node can also be a node that implements a particular core network function (NF), such as an access and mobility management function (AMF), a session management function (AMF), a user plane function (UPF), a Service Capability Exposure Function (SCEF), or the like.
Network Node: As used herein, a “network node” is any node that is part of the core network (e.g., a core network node discussed above) of a telecommunications network. Functionally, a network node is equipment capable, configured, arranged, and/or operable to communicate directly or indirectly with a wireless or wired device and/or with other network nodes or equipment in the telecommunications network, to enable and/or provide wireless or wired access to the telecommunication device, and/or to perform other functions (e.g., administration) in the telecommunications network.
Node: As used herein, the term “node” (without any prefix) can be any type of node that is capable of operating in or with a telecommunication network (including a RAN and/or a core network), including a radio access node (or equivalent term), core network node, or telecommunications device.
Service: As used herein, the term “service” refers generally to a set of data, associated with one or more applications, which is to be transferred via a network with certain specific delivery requirements that need to be fulfilled in order to make the applications successful.
Component: As used herein, the term “component” refers generally to any component needed for the delivery of a service. Examples of component are RANs (e.g., E-UTRAN, NG-RAN, or portions thereof such as eNBs, gNBs, base stations (BS), etc.), CNs (e.g., EPC, 5GC, or portions thereof, including all type of links between RAN and CN entities), and cloud infrastructure with related resources such as computation, storage. In general, each component can have a “manager”, which is an entity that can collect historical information about utilization of resources as well as provide information about the current and the predicted future availability of resources associated with that component (e.g., a RAN manager).

Note that the description given herein focuses on a 3GPP telecommunications system and, as such, 3GPP terminology or terminology similar to 3GPP terminology is generally used. However, the concepts disclosed herein are not limited to a 3GPP system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from the concepts, principles, and/or embodiments described herein.

In addition, functions and/or operations described herein as being performed by a telecommunications device or a network node may be distributed over a plurality of telecommunications devices and/or network nodes.

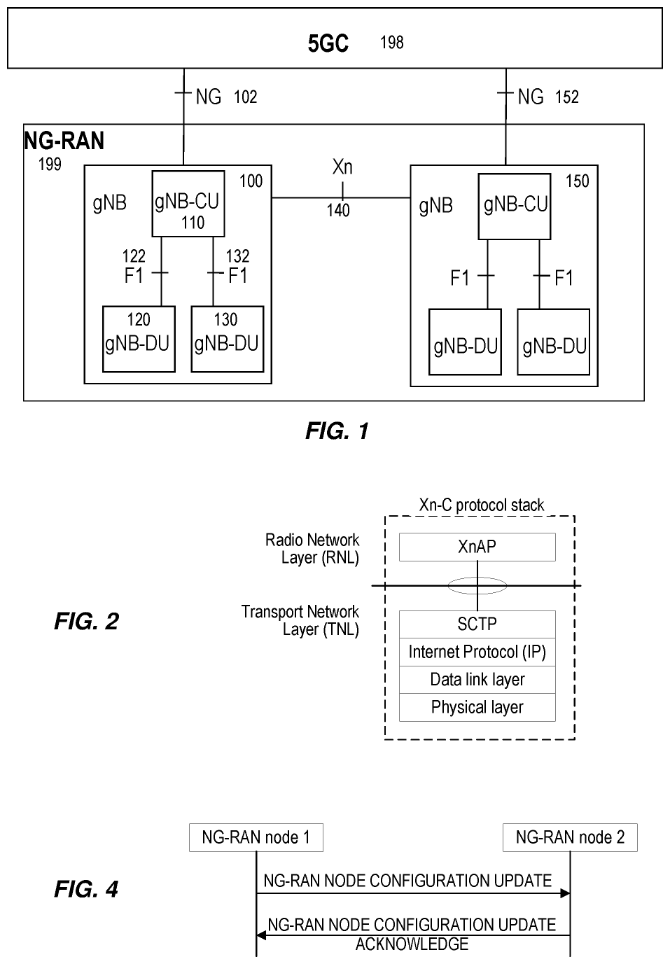

Conventionally, telecommunication equipment was provided as integrated software and hardware. More recently, virtualization technologies decouple software and hardware such that network functions (NFs) can be executed on commercial off-the-shelf (COTS) hardware. For example, mobile networks can include virtualized network functions (VNFs) and non-virtualized network elements (NEs) that perform or instantiate a NF using dedicated hardware. In the context of the exemplary 5G network architecture shown in FIG. 1, various NG-RAN nodes (e.g., CU) and various NFs in 5GC can be implemented as combinations of VNFs and NEs.

In general, a (non-virtual) NE can be considered as one example of a physical network function (PNF). From a high-level perspective, a VNF is equivalent to the same NF realized by an NE. However, the relation between NE and VNF instances depends on the relation between the corresponding NFs. A NE instance is 1:1 related to a VNF instance if the VNF contains the entire NF of the NE. Even so, multiple instances of a VNF may run on the same NF virtualization infrastructure (NFVI, e.g., cloud infrastructure, data center, etc.).

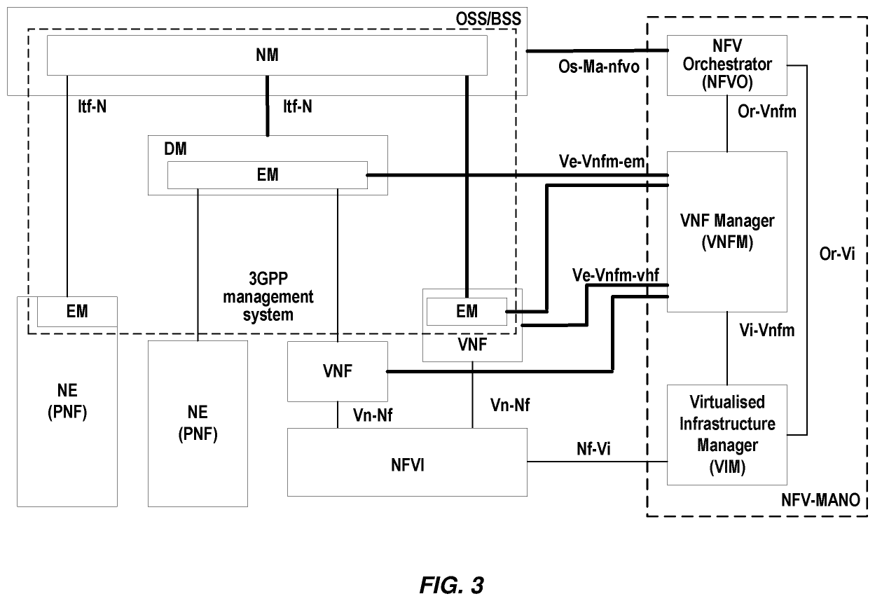

Both VNFs and NEs need to be managed in a consistent manner. To facilitate this, 3GPP specifies a Network Function Virtualisation Management and Orchestration (NFV-MANO) architectural framework. FIG. 3 shows an exemplary mobile network management architecture mapping relationship between NFV-MANO architectural framework and other parts of a 3GPP-specified network. The arrangement shown in FIG. 3 is described in detail in 3GPP TS 28.500 (v17.0.0) section 6.1, the entirety of which is incorporated herein by reference. Certain portions of this description are provided below for context and clarity.

The architecture shown in FIG. 3 includes the following entities, some of which are further defined in 3GPP TS 32.101 (v17.0.0):
Network Management (NM), which plays one of the roles of operation support system (OSS) or business support system (BSS) and is the consumer of reference point Os-Ma-nfvo;
Device Management (DM)/Element Management (EM), if the EM includes the extended functionality, it can manage both PNFs and VNFs;
NFV Orchestrator (NFVO);
VNF Manager (VNFM);
Virtualized infrastructure manager (VIM);
Itf-N, interface between NM and DM/EM;
Os-Ma-nfvo, reference point between OSS/BSS and NFVO;
Ve-Vnfm-em, reference point between EM and VNFM;
Ve-Vnfm-vnf, reference point between VNF and VNFM; and
NFVI, the hardware and software components that together provide the infrastructure resources where VNFs are deployed.

EM/DM is responsible for FCAPS (fault, configuration, accounting, performance, security) management functionality for a VNF on an application level and NE on a domain and element level. This includes:
Fault management for VNF and physical NE.
Configuration management for VNF and physical NE.
Accounting management for VNF and physical NE.
Performance measurement and collection for VNF and physical NE.
Security management for VNF and physical NE.
VNF lifecycle management (LCM), such as requesting LCM for a VNF by VNFM and exchanging information about a VNF and virtualized resources associated with a VNF.

As briefly mentioned above, the Xn interface between NG-RAN nodes (e.g., gNBs) include various global procedures. One of those is configuration update, whereby NG-RAN nodes can inform each other about updates to the configurations provided during Xn interface establishment. Such updates can include information about addition, deletion, and/or modification of served (i.e., own) NR cells, neighboring NR cells served by neighbor gNBs, and neighboring LTE cells served by base stations (called eNBs) in LTE E-UTRAN.

FIG. 4 illustrates exemplary signaling for the configuration update procedure, in which NG-RAN node 1 sends an NG-RAN NODE CONFIGURATION UPDATE message with the updated configuration information to NG-RAN node 2, which responds with an NG-RAN NODE CONFIGURATION UPDATE ACKNOWLEDGE message. As mentioned above, such updates can include information about addition, deletion, and/or modification of served (i.e., own) NR cells, neighboring NR cells served by neighbor gNBs, and neighboring LTE cells served by base stations (called eNBs) in LTE E-UTRAN. Since the maximum number of cells served by an NG-RAN node is 16384, the amount of information exchanged during a configuration update procedure between gNBs can be substantial.

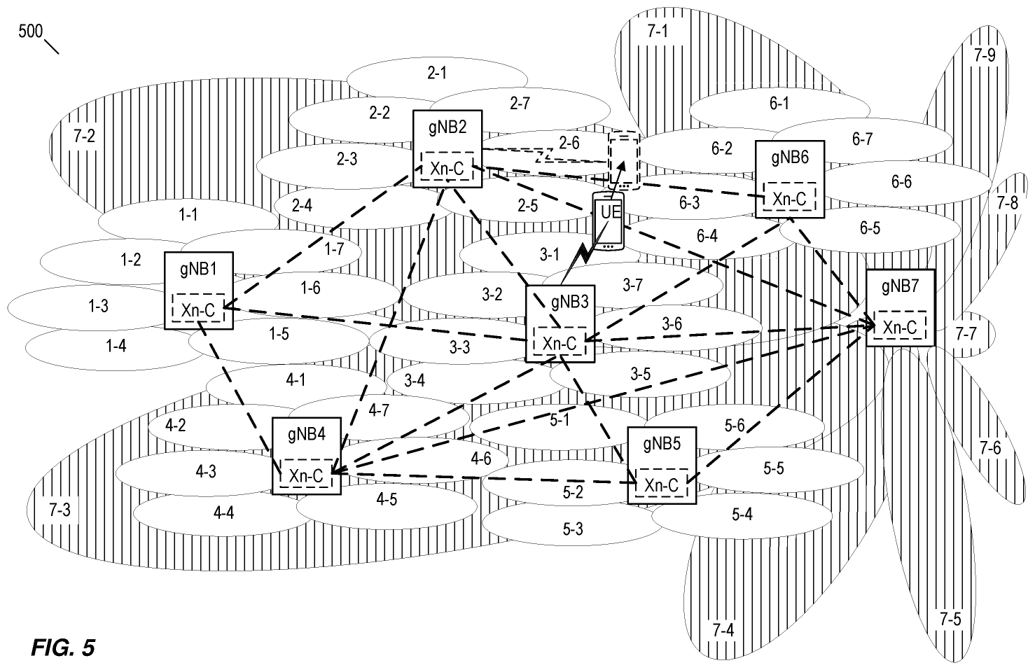

FIG. 5 shows an exemplary radio access network (RAN) comprising seven (7) gNBs that serve a plurality of cells in a coverage area. In particular, gNBs 1-6 serve respective small coverage areas while gNB 7 serves a large coverage area that overlaps with the small coverage areas of gNBs 1-6. In this sense, gNBs 1-6 can be considered micro gNBs and gNB 7 can be considered a macro gNB. Each of gNBs 1-6 serves a small number (e.g., six or seven) of cells in their small coverage areas, while gNB 7 serves a much larger number of cells throughout its large coverage (although only nine are shown in FIG. 5). As a specific deployment example, each of gNBs 1-6 can serve a shopping mall, an office building, an apartment complex, etc. while gNB 7 serves a metropolitan area that includes the shopping mall, the office building, the apartment complex, etc.

FIG. 5 also shows a UE that communicates with gNB3 via cell 3-1. While being served by cell 3-1, the UE can perform measurements of neighbor cells and report these measurements to gNB3. In the example scenario shown in FIG. 4, the UE can detect and measure signals from cell 2-5 served by gNB2, cells 6-3 and 6-4 served by gNB6, cell 7-2 served by gNB7, and cell 3-7 served by gNB3. Although not shown, other UEs in other cells served by gNB3 can perform and report measurements of other cells served by neighboring gNBs.

Each of the gNBs in FIG. 5 includes an Xn-C protocol stack such as shown in FIG. 2, which it uses for point-to-point communication via Xn interfaces with other neighboring gNBs. For example, gNB3 has point-to-point Xn interfaces with all other gNBs in the exemplary network arrangement. When the configuration of any of gNB3's cells changes, gNB3 initiates respective configuration update procedures (e.g., as shown in FIG. 4) towards the other gNBs to inform them of this change.

Likewise, macro gNB7 also has point-to-point Xn interfaces with all other gNBs in the exemplary network arrangement (although some are not shown for clarity). Furthermore, gNB7's many cells are likely to overlap with (or be adjacent to) coverage areas of additional gNBs (e.g., other micro gNBs) not shown, so it is likely that gNB7 also has point-to-point Xn interfaces with these additional gNBs. When the configuration of any of gNB7's cells changes, gNB7 initiates respective configuration update procedures (e.g., as shown in FIG. 4) towards other gNBs to inform them of this change.

For example, gNB7 will inform gNB3 about any configuration update involving any of gNB7's many cells. As shown in FIG. 5, however, cells 7-1 and 7-2 are the only cells served by gNB7 that overlap with gNB3's coverage area (e.g., a shopping mall). It is necessary for gNB3 to receive gNB7's configuration updates for cells 7-1 and 7-2, but gNB7's configuration updates for the many other cells that it serves are unnecessary and of no interest to gNB3. This condition is also true for micro gNBs 1-2 and 4-6 whose respective coverage areas overlap with only 2-3 of the cells served by gNB7.

As such, the current NG-RAN node configuration update procedure can create a significant amount of excess Xn signaling in scenarios such as illustrated by FIG. 5. Even in a scenario with only micro gNBs (e.g., gNBs 1-6) serving small cells, many updates to each micro gNB's small cells will only be of interest to a subset of the other micro gNBs. However, all micro gNBs will receive all configuration updates from all other Xn-connected micro gNBs.

Typically, signaling, CPU, and memory resources of micro gNBs (or other nodes serving small coverage areas) are limited in comparison to macro gNB resources. This can reduce the per-gNB deployment cost, which balances against the larger number of micro gNBs that must be deployed to cover a given area (e.g., as compared to macro gNBs). However, the excess signaling caused by configuration update procedures can severely tax the limited signaling, CPU, and memory resources of micro gNBs. More generally, this excess signaling causes excessive network energy consumption and over-dimensioning of signaling resources, thereby negating other advantages of micro gNB deployment.

There are various reasons why these problems are expected to be worse in future deployments. First, many future NR deployments will be in higher-frequency (e.g., millimeter wave) spectrum in which signal propagation is more limited. Thus, a greater number of smaller cells will be needed for a given coverage area, which will require a greater number of gNBs and/or a greater number of cells per gNB. Second, it is expected that integrating new NR deployments with existing (or legacy) vendor implementations (e.g., for LTE) will increase the need for exchanging cell update information between nodes.

Third, many future NR deployments are expected to follow cloud-native RAN architectures that implement RAN functions (e.g., gNB CU and DU) in generic computing platforms (including hardware acceleration) using cloud-native software principles such as microservices, containers, and virtualization. Since gNB functionality will be more centralized, this will increase the number of cells that a “logical” gNB can serve.

Fourth, network energy saving is expected to become more important. For example, an NG-RAN may dynamically reallocate cells so that certain gNBs can be powered down or operated in a reduced-energy state. In such case, the gNBs subject to the reallocation need to perform configuration update procedures toward peer gNBs.

One possible solution is to send a partial list of cells during an NG-RAN node configuration update procedure. Currently, however, an NG-RAN node is unable to determine which of its served cells are relevant for each peer (e.g., neighboring) NG-RAN node. Sending a partial list of the NG-RAN node's choosing is likely to provide irrelevant information and/or omit relevant information for each peer NG-RAN node.

Accordingly, embodiments of the present disclosure address these and other problems, issues, and/or difficulties by techniques for efficient sharing and/or distribution of cell configuration data among NG-RAN nodes (e.g., gNBs).

In some embodiments, a centralized cell configuration tracking architecture can be employed. Each gNB registers its served cells with a centralized tracking node and declares that it holds a copy of the configurations for its served cells. This can be considered a “torrent” or “seed.” Each gNB also registers it's network address (e.g., as a torrent termination endpoint) to enable others to request cell configurations from that gNB. As other gNBs download copies of the cell configurations, they also register their copies with the tracking node in a similar manner. The tracking node can provide to requesting nodes a list of gNBs (e.g., network addresses) that are registered as holding a configuration for a cell of interest. When the gNB that serves the cell updates the cell configuration, it also notifies the tracking node of this update. The tracking node then informs all gNBs registered as holding a configuration for that cell about the update, and these registered gNBs can obtain the updated cell configuration in a similar manner as they obtained the original cell configuration.

Other embodiments are based on a decentralized or distributed cell configuration tracking architecture. Put differently, each NG-RAN node (e.g., gNB) can operate as a distributed tracking node for cell configurations. Each gNB registers its served cells with its closest peer gNBs and declares that it holds a copy of the configurations for its served cells. When queried by another gNB for a configuration for a cell of interest, the peer gNB provides the other gNB with a list of gNBs (e.g., network addresses) that it has registered as holding the desired cell configuration, or an indication that it has none registered (e.g., an empty list). Once the other gNB obtains a non-empty list for the cell of interest from one of its peer gNBs, it can query an address on the list for the desired cell configuration. In this manner, gNBs can store and provide cell configurations for their own served cells as well as for cells served by other gNBs. Once the other gNB obtains the desired cell configuration, it can register this information with its peer gNBs.

When a gNB updates a cell configuration for one of its served cells, it notifies its peer gNBs (i.e., distributed tracking nodes) of this update. The peer gNB then informs all gNBs registered as holding a configuration for that cell about the update, and these registered gNBs can obtain the updated cell configuration in a similar manner as they obtained the original cell configuration.

Embodiments described herein provide various benefits and/or advantages. For example, embodiments eliminate the need for a gNB to send configurations for all of its served cells to all peer gNBs, as well as the need to send configuration updates to all peer gNBs. This reduces and/or minimizes the amount of inter-node signaling for cell management, such as when cells are deactivated to reduce network energy consumption. Additionally, since a gNB can obtain a configuration for a newly found cell (e.g., reported by a UE in a measurement report) as needed, this reduces the amount of cell configuration information needing to be stored in gNB memory, thereby reducing cost and complexity. This can be particular advantageous for micro gNBs or other NG-RAN nodes requiring low complexity.

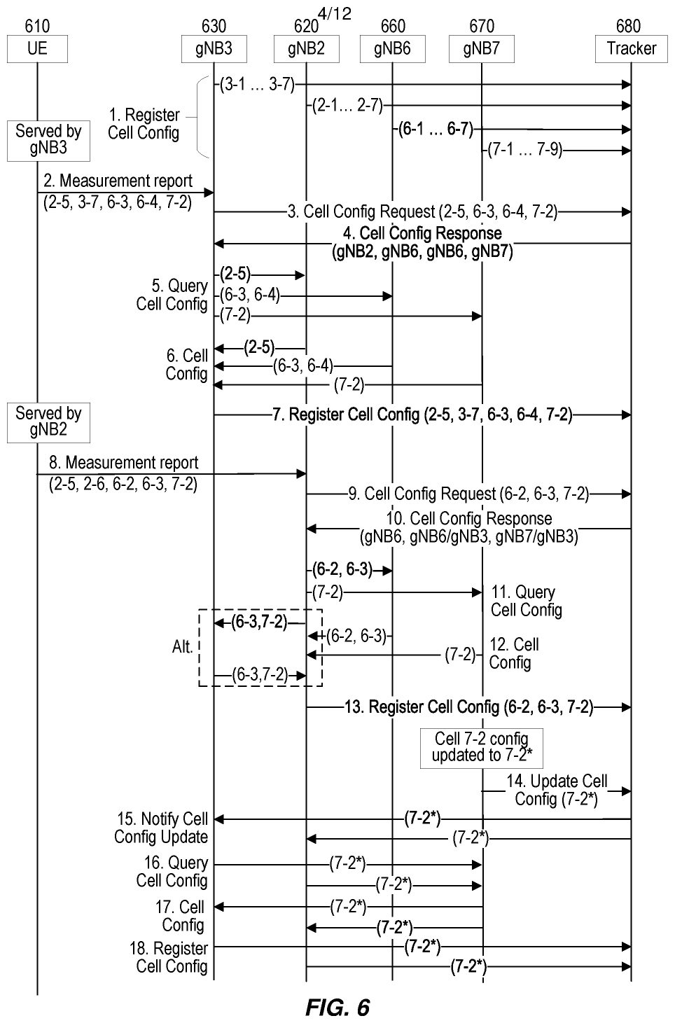

FIG. 6 shows a signaling diagram for an exemplary centralized cell configuration tracking architecture, according to some embodiments of the present disclosure. In particular, the example shown in FIG. 6 is based on the exemplary network arrangement of seven (7) gNBs shown in FIG. 5 and discussed above. More specifically, FIG. 6 shows signaling between a centralized tracking node (Tracker 680) and gNBs 2-3 and 6-7 shown in FIG. 5, denoted with references numbers 620, 630, 660, and 670, respectively. Although the operations shown in FIG. 6 are given numerical labels, this is done to facilitate explanation rather than to require or imply a sequential order, unless stated to the contrary below. Furthermore, the message names shown in FIG. 6 are merely exemplary.

In operation 1, each of gNBs 2-3 and 6-7 registers its respective served cells with the tracker and declares that it holds a copy of the configurations for the served cells. For example, gNB3 registers its served cells 3-1 through 3-7 with the tracker and declares that it holds a copy of the configurations for cells 3-1 through 3-7. The tracker stores or registers respective associations between the gNBs and the cell configurations that they store, which at this point is only for served cells.

Initially, the UE is served by cell 3-1 of gNB3, as illustrated in FIG. 5. In operation 2, the UE sends a measurement report to gNB3, with measurements of cells 2-5 (served by gNB2), cell 3-7 (served by gNB3), cells 6-3 and 6-4 (served by gNB6), and 7-2 (served by gNB7). In operation 3, after determining that it does not have configurations for the cells 2-5, 6-3, 6-4, and 7-2, gNB3 sends a Cell Config Request message to the tracker, requesting configurations for these four cells. In operation 4, the tracker responds with a Cell Config Response message indicating the network nodes that previously registered (e.g., in operation 1) as holding configurations for the four requested cells.

Based on the information received in operation 4, gNB3 queries gNB2, gNB6, and gNB7 for configurations for cells 2-5, 6-3/6-4, and 7-2, respectively, in operation 5. Based on the respective queries, these gNBs respond with the requested cell configurations in operation 6, which gNB3 then stores and uses as needed (e.g., for handover preparation for the UE). In operation 7, gNB3 registers its stored configurations for cells 2-5, 6-3, 6-4, and 7-2 with the tracker, which updates the registered associations between gNB3 and the cell configurations that it stores.

Subsequently, the UE moves such that it is now served by gNB2. In operation 8, the UE sends a measurement report to gNB2, with measurements of cells 2-5 and 2-6 (served by gNB2), cells 6-2 and 6-3 (served by gNB6), and cell 7-2 (served by gNB7). In operation 9, after determining that it does not have configurations for the cells 6-2, 6-3, and 7-2, gNB2 sends a Cell Config Request message to the tracker, requesting configurations for these three cells. In operation 10, the tracker responds with a Cell Config Response message indicating the network nodes that previously registered (e.g., in operations 1 and 7) as holding configurations for the three requested cells. In this case, the tracker indicates two sources for cell 6-3 configuration (i.e., gNB6/gNB3) and two sources for cell 7-2 configuration (e.g., gNB7/gNB3).

Based on the information received in operation 10, gNB2 queries gNB6 and gNB7 for configurations for cells 6-2/6-3 and 7-2, respectively, in operation 11. Based on the respective queries, these gNBs respond with the requested cell configurations in operation 12, which gNB2 then stores and uses as needed (e.g., for handover preparation for the UE). As an alternative shown in FIG. 6, gNB2 can query gNB3 for configurations for cells 6-3 and 7-2, which gNB3 can provide in response. For example, gNB2 may be a nearest neighbor (or closest peer node) for gNB3, gNB2 may have a direct communication interface to gNB3, and/or gNB2 may have no direct communication interface to other peer gNBs that hold the cell configurations of interest. In operation 13, gNB2 registers its stored configurations for cells 6-2, 6-3, and 7-2 with the tracker, which updates the registered associations between gNB2 and the cell configurations that it stores.

Subsequently, gNB7 updates the configuration for cell 7-2, with the updated configuration being denoted 7-2* in FIG. 6. In operation 14, gNB7 sends to the tracker an Update Cell Config message that indicates the update of cell 7-2 configuration to 7-2*. For example, gNB7 can provide a hash value of configuration 7-2*, which will be different than a hash value of the configuration 7-2 previously registered with the tracker in operation 1. The tracker updates the registered association between gNB2 and its updated configuration 7-2*.

In operation 15, the tracker sends notifications about the update to cell 7-2 to gNBs 2 and 3, each of which previously registered as holding configuration 7-2. Based on the information received in operation 15, gNBs 2 and 3 query gNB7 for updated configuration 7-2* in operation 16. In operation 17, gNB7 responds to the respective queries with the requested cell configuration 7-2*, which gNBs 2 and 3 store and use as needed (e.g., for UE handover preparation). In operation 7, gNBs 2 and 3 registered their stored configurations 7-2* with the tracker, which updates the registered associations between these gNBs and the cell configurations that they store.

Note that operations 16-17 may not immediately follow operation 15, or may not be performed at all. In other words, gNBs 2 and/or 3 may forego querying gNB7 for updated configuration 7-2* until some later time as needed. Alternately, gNBs 2 and/or 3 may refrain from querying gNB7 for updated configuration 7-2*. Put differently, it is left to individual discretions of gNBs 2 and 3 whether and/or when to query gNB7 for configuration 7-2*.

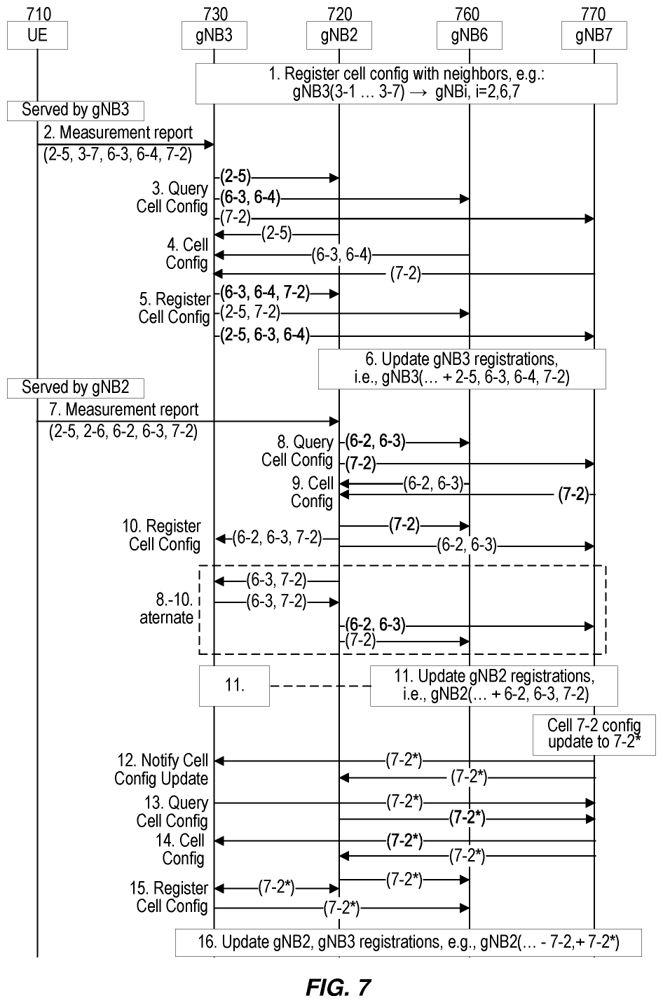

FIG. 7 shows a signaling diagram for an exemplary decentralized or distributed cell configuration tracking architecture, according to other embodiments of the present disclosure. In particular, the example shown in FIG. 7 is based on the exemplary network arrangement of seven (7) gNBs shown in FIG. 5 and discussed above. More specifically, FIG. 7 shows signaling between gNBs 2-3 and 6-7 shown in FIG. 5, denoted with references numbers 720, 730, 760, and 770, respectively. Although the operations shown in FIG. 7 are given numerical labels, this is done to facilitate explanation rather than to require or imply a sequential order, unless stated to the contrary below. Furthermore, the message names shown in FIG. 7 are merely exemplary.

In operation 1, each of gNBs 2-3 and 6-7 registers its served cells with the peer gNBs and declares that it holds a copy of the configurations for the served cells. For example, gNB3 registers its served cells 3-1 through 3-7 with the gNBs 2, 6, and 7 and declares that it holds a copy of the configurations for cells 3-1 through 3-7. Each gNB store or registers respective associations between peer gNBs and the cell configurations that they store, which at this point is only for served cells.

Initially, the UE is served by cell 3-1 of gNB3, as illustrated in FIG. 5. In operation 2, the UE sends a measurement report to gNB3, with measurements of cells 2-5 (served by gNB2), cell 3-7 (served by gNB3), cells 6-3 and 6-4 (served by gNB6), and 7-2 (served by gNB7). In operation 3, after determining that it does not have configurations for the cells 2-5, 6-3, 6-4, and 7-2, and based on the registrations performed in operation 1, gNB3 queries gNB2, gNB6, and gNB7 for configurations for cells 2-5, 6-3/6-4, and 7-2, respectively. These gNBs respond to the respective queries with the requested cell configurations in operation 4, which gNB3 then stores and uses as needed (e.g., for handover preparation for the UE). In operations 5-6, gNB3 registers its stored configurations for cells 2-5, 6-3, 6-4, and 7-2 with the peer gNBs, which update their respective registered associations between gNB3 and the cell configurations that it stores.

Subsequently, the UE moves such that it is now served by gNB2. In operation 7, the UE sends a measurement report to gNB2, with measurements of cells 2-5 and 2-6 (served by gNB2), cells 6-2 and 6-3 (served by gNB6), and cell 7-2 (served by gNB7). In operation 8, after determining that it does not have configurations for the cells 6-2, 6-3, and 7-2, and based on the registrations performed in operation 1, gNB2 queries gNB6 and gNB7 for these configurations. These gNBs respond to the respective queries with the requested cell configurations in operation 9. In operations 10-11, gNB3 registers its stored configurations for cells 6-2, 6-3, and 7-2 with the peer gNBs, which update their respective registered associations between gNB2 and the cell configurations that it stores.

An alternative to operations 8-10 is also shown in FIG. 7. In alternative operation 8, based on the registrations performed in operations 5-6, gNB2 queries gNB3 for the configurations of cells 6-3 and 7-2. For example, gNB3 may be a nearest neighbor (or closest peer node) for gNB2, gNB2 may have a direct communication interface to gNB3, and/or gNB2 may have no direct communication interface to other peer gNBs that hold the cell configurations of interest. In operation 9, gNB3 responds to the query with the requested cell configurations, which gNB2 then stores and uses as needed (e.g., for handover preparation for the UE). In operation 10, gNB3 registers its stored configurations for cells 6-2, 6-3, and 7-2 with peer gNBs 6 and 7. In operation 11, gNBs 3 and 6-7 update their respective registered associations between gNB2 and the cell configurations that it stores.

Subsequently, gNB7 updates the configuration for cell 7-2, with the updated configuration being denoted 7-2* in FIG. 7. In operation 12, gNB7 sends notifications about the update to cell 7-2 to gNBs 2 and 3, each of which previously registered as holding configuration 7-2. For example, gNB7 can provide a hash value of configuration 7-2*, which will be different than a hash value of the configuration 7-2 previously registered with the tracker in operation 1.

Based on the information received in operation 12, gNBs 2 and 3 query gNB7 for updated configuration 7-2* in operation 13. In operation 14, gNB7 responds to the respective queries with the requested cell configuration 7-2*, which gNBs 2 and 3 store and use as needed (e.g., for UE handover preparation). In operation 7, gNB2 registers its stored configuration 7-2* with peer gNBs 3 and 6, and gNB3 registers its stored configuration 7-2* with peer gNBs 2 and 6. In operation 16, All gNBs update their respective registered associations between peer gNBs and cell configuration 7-2*.

Note that operations 13-16 may not immediately follow operation 12, or may not be performed at all. In other words, gNBs 2 and/or 3 may forego querying gNB7 for updated configuration 7-2* until some later time as needed. Alternately, gNBs 2 and/or 3 may refrain from querying gNB7 for updated configuration 7-2*. Put differently, it is left to individual discretions of gNBs 2 and 3 whether and/or when to query gNB7 for configuration 7-2*.

Note that the exemplary decentralized architecture scenario shown in FIG. 7 is somewhat simplified compared to actual RAN deployments. For example, all gNBs know which peer gNBs store which cell configurations based on the initial registration in operation 1 and updates in operations 6, 11, and 16. In actual RAN deployments, however, there will be many more gNBs and each gNB will not have complete knowledge of which peer gNBs store which cell configurations. Thus, a gNB may need to start by sending a query to nearest neighbor gNBs and, if unsuccessful, to other gNBs more distant. As a specific example in the context of FIG. 7 operation 3, gNB3 can initially query gNB2 for configurations for cells 6-3/6-4 and, if unsuccessful, then query gNB6.

The various messages between peer gNBs in FIGS. 6-7 and between gNBs and the tracker in FIG. 6 can be implemented by various protocols running on top of any appropriate transport layer. For example, the various messages shown in FIGS. 6-7 can be implemented in a protocol that runs on top of the TNL protocols shown in FIG. 2, such as the XnAP protocol or in a protocol newly defined for the purpose of cell configuration distribution. Alternately, the various messages shown in FIGS. 6-7 can be implemented in a protocol that runs on top of the transport layer of the NG interface between NG-RAN nodes and 5GC, such as in FIG. 1. Alternately, when the tracker is deployed in OSS/BSS, the messages between gNBs and the tracker can be part of a protocol associated with reference point Os-Ma-nfvo, such as described above in relation to FIG. 4.

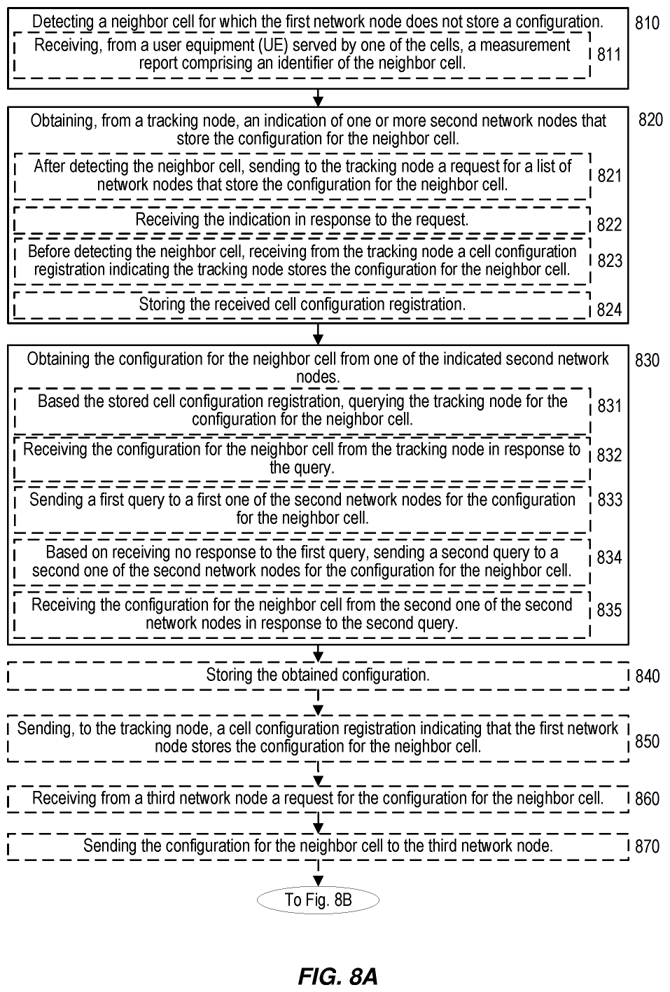

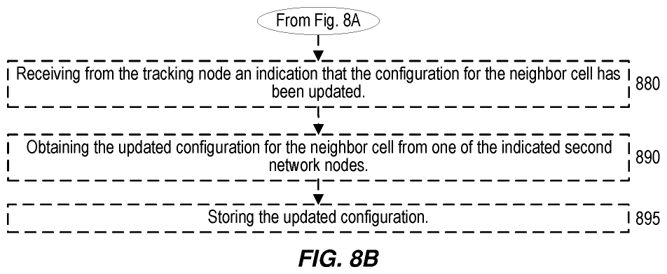

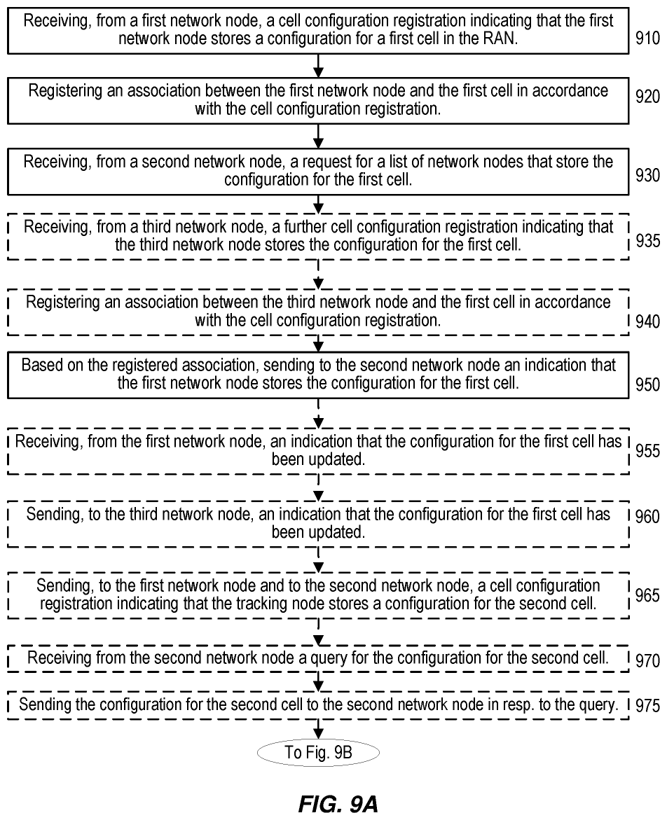

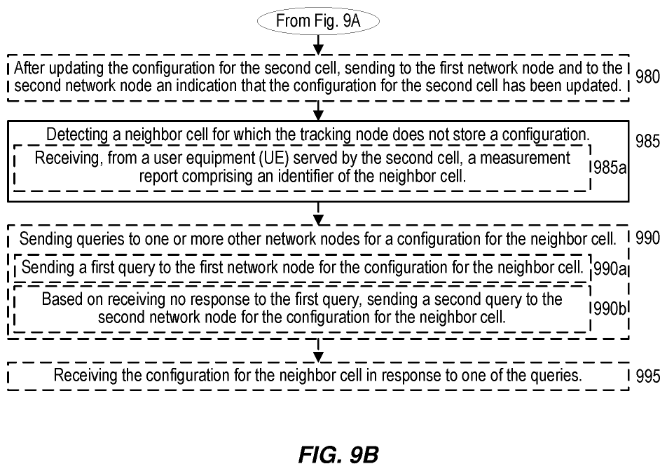

The embodiments described above can be further illustrated with reference to FIGS. 8-9, which depict exemplary methods (e.g., procedures) for a first network node and a tracking node, respectively. Put differently, various features of the operations described below correspond to various embodiments described above. The exemplary methods shown in FIGS. 8-9 can be used cooperatively (e.g., with each other and with other procedures described herein) to provide benefits, advantages, and/or solutions to problems described herein. Although the exemplary methods are illustrated in FIGS. 8-9 by specific blocks in particular orders, the operations corresponding to the blocks can be performed in different orders than shown and can be combined and/or divided into blocks and/or operations having different functionality than shown. Optional blocks and/or operations are indicated by dashed lines.

In the context of FIGS. 8-9, the term “tracking node” is used generically to mean any network node that tracks cell configuration storage, with specific embodiments of “tracking nodes” mentioned at various points in the following description.

FIG. 8 (which includes FIGS. 8A-B) illustrates an exemplary method (e.g., procedure) for a first network node configured to serve one or more cells in a RAN (e.g., NG-RAN), according to various embodiments of the present disclosure. The exemplary method shown in FIG. 8 can be performed by a RAN node (e.g., base station, eNB, gNB, ng-eNB, etc.) such as described elsewhere herein.

The exemplary method can include the operations of block 810, where the first network node can detect a neighbor cell for which the first network node does not store a configuration. The exemplary method can also include the operations of block 820, where the first network node can obtain, from a tracking node, an indication of one or more second network nodes that store the configuration for the neighbor cell. The exemplary method can also include the operations of block 830, where the first network node can obtain the configuration for the neighbor cell from one of the indicated second network nodes.

In some embodiments, detecting the neighbor cell in block 810 includes the operations of sub-block 811, where the first network node can receive, from a UE served by one of the cells, a measurement report comprising an identifier of the neighbor cell.

In some embodiments, the exemplary method can also include the operations of blocks 840-850, where the first network node can store the obtained configuration (e.g., from block 830) and send to the tracking node a cell configuration registration indicating that the first network node stores the configuration for the neighbor cell. In some of these embodiments, the exemplary method can also include the operations of blocks 860-870, where after sending the cell configuration registration, the first network node can receive from a third network node a request for the configuration for the neighbor cell and send the configuration for the neighbor cell to the third network node. FIG. 6 operations 11-12 and FIG. 7 operations 8-9 are examples of the operations of blocks 840-850.

In some of these embodiments, the exemplary method can also include the operations of blocks 880-895. In block 880, after sending the cell configuration registration (e.g., in block 850), the first network node can receive from the tracking node an indication that the configuration for the neighbor cell has been updated. In blocks 890-895, the first network node can obtain the updated configuration for the neighbor cell from one of the indicated second network nodes and store the updated configuration. FIG. 6 operations 15-17 and FIG. 7 operations 12-14 are examples of the operations of blocks 880-895.

In some embodiments, obtaining the indication of the one or more second network nodes in block 820 includes the operations of sub-blocks 821-822, where after detecting the neighbor cell (e.g., in block 810), the first network node can send to the tracking node a request for a list of network nodes that store the configuration for the neighbor cell and receive the indication in response to the request. FIG. 6 operations 3-4 are examples the operations of sub-blocks 821-822, particularly for the centralized cell configuration tracking architecture. In these embodiments, the tracking node does not serve any cells in the RAN and/or the tracking node does not store any configurations for any cells in the RAN. Rather, such operations are performed by RAN nodes, such as the first network node.

In other embodiments, the tracking node is a network node that serves one or more cells in the RAN. FIG. 7 shows an example of these embodiments, particularly for the decentralized or distributed cell configuration tracking architecture. In some variants, the one or more cells served by the tracking node do not include the neighbor cell. In other words, the tracking node stores configurations for cells served by other network nodes, as well as configurations for cells that it serves.

In some of these embodiments, the tracking node is one of the second network nodes (e.g., indicated in block 820) and obtaining the indication in block 820 includes the operations of sub-blocks 823-824, where before detecting the neighbor cell (e.g., in block 810), the first network node can receive from the tracking (second network) node a cell configuration registration indicating that the tracking node stores the configuration for the neighbor cell and store the received cell configuration registration. In such embodiments, obtaining the configuration for the neighbor cell in block 830 can include the operations of sub-blocks 831-832, where based on the stored cell configuration registration, the first network node can query the tracking node for the configuration for the neighbor cell and receive the configuration for the neighbor cell from the tracking node in response to the query. FIG. 7 operations 1 and 3-4 are examples of the operations described above in this paragraph.

In other of these embodiments, obtaining the configuration for the neighbor cell in block 830 includes the first network node performing the following operations, labelled with corresponding sub-block numbers:
(833) sending a first query to a first one of the second network nodes for the configuration for the neighbor cell;
(834) based on receiving no response to the first query, sending a second query to a second one of the second network nodes for the configuration for the neighbor cell; and
(835) receiving the configuration for the neighbor cell from the second one of the second network nodes in response to the second query.

In some of these embodiments, the order of the first and second queries is determined based on one or more of the following:
the first one of the second network nodes is the closest peer node to the first network node;
the first network node has a direct communication interface to the first one of the second network nodes; and
the first network node has no direct communication interface to the second one of the second network nodes.

In addition, FIG. 9 (which includes FIGS. 9A-B) illustrates an exemplary method (e.g., procedure) for tracking node configured to track cell configurations for cells of a RAN (e.g., NG-RAN), according to various embodiments of the present disclosure. For example, the exemplary method shown in FIG. 9 can be performed by a tracking node (e.g., base station, eNB, gNB, ng-eNB, OAM node, host computing node, etc.) such as described elsewhere herein.

The exemplary method can include the operations of block 910, where the tracking node can receive, from a first network node, a cell configuration registration indicating that the first network node stores a configuration for a first cell in the RAN. The exemplary method can also include the operations of block 920, where the tracking node can register an association between the first network node and the first cell in accordance with the cell configuration registration. The exemplary method can also include the operations of block 930, where the tracking node can subsequently receive, from a second network node, a request for a list of network nodes that store the configuration for the first cell. The exemplary method can also include the operations of block 950, where based on the registered association, the tracking node can send to the second network node an indication that the first network node stores the configuration for the first cell.

In some embodiments, the exemplary method can also include the operations of blocks 935-940, where the tracking node can receive, from a third network node, a further cell configuration registration indicating that the third network node stores the configuration for the first cell and register an association between the third network node and the first cell in accordance with the cell configuration registration. FIG. 6 operation 7 and FIG. 7 operations 5-6 are examples of the operations of blocks 935-940. In such case, the indication in block 950 also indicates that the third network node stores the configuration for the first cell, based on the registered associations.

In some of these embodiments, the first network node serves the first cell and the exemplary method also includes the operations of blocks 955-960, where the tracking node can receive from the first network node an indication that the configuration for the first cell has been updated and send to the third network node, an indication that the configuration for the first cell has been updated. FIG. 6 operations 14-15 are examples of the operations of blocks 955-960.

In some embodiments, the tracking node stores, for each of a plurality of cells in the RAN, an indication of one or network nodes in the RAN that store a configuration for that cell. Note that this does not mean that the tracking node necessarily stores indications for all cells in the RAN. FIG. 6 shows an example of these embodiments, particularly for the centralized cell configuration tracking architecture. In these embodiments, the tracking node does not serve any cells in the RAN and/or the tracking node does not store any configurations for any cells in the RAN. Rather, such operations are performed by RAN nodes, such as the first network node.

In other embodiments, the tracking node is a network node that serves a second cell in the RAN. FIG. 7 shows an example of these embodiments, particularly for the decentralized or distributed cell configuration tracking architecture. In these embodiments, the exemplary method can also include the operations of block 965, where the tracking node can send, to the first network node and to the second network node, a cell configuration registration indicating that the tracking node stores a configuration for the second cell. FIG. 7 operation 10 is an example of the operations of block 965.

In some of these embodiments, the exemplary method can also include the operations of blocks 970-975, where after sending the cell configuration registration, the tracking node can receive from the second network node a query for the configuration for the second cell and send the configuration for the second cell to the second network node in response to the query. Alternate operations 8-9 in FIG. 7 are examples of operations 970-975.

In some of these embodiments, the exemplary method can also include the operations of block 980, where after updating the configuration for the second cell, the tracking node can send to the first network node and to the second network node an indication that the configuration for the second cell has been updated. FIG. 7 operation 12 is an example of the operations of block 980.

In some of these embodiments, the exemplary method can also include the operations of blocks 985-995, where the tracking node can detect a neighbor cell for which the tracking node does not store a configuration, send queries to one or more other network nodes for a configuration for the neighbor cell, and receive the configuration for the neighbor cell in response to one of the queries. FIG. 7 operations 7-9 are examples of the operations of blocks 985-995. In some of these embodiments, detecting the neighbor cell in block 985 includes the operations of sub-block 985a, where the tracking node can receive, from a UE served by the second cell, a measurement report comprising an identifier of the neighbor cell.

In some variants of these embodiments, the neighbor cell is the first cell, a query is sent (e.g., in block 990) to the first network node based on the registered association, and the configuration is received from the first network node.

In other variants of these embodiments, the neighbor cell is a cell other than the first cell and sending the query to one or more other network nodes in block 990 includes the operations of sub-blocks 990a-b, where the tracking node can send a first query to the first network node for the configuration for the neighbor cell and, based on receiving no response to the first query, send a second query to the second network node for the configuration for the neighbor cell. The configuration is received from the second network node in response to the second query. In some further variants of these embodiments, the order of the first and second queries is determined based on one or more of the following:
the first network node is the closest peer node to the tracking node;
the tracking node has a direct communication interface to the first network node; and
the tracking node has no direct communication interface to the second network node.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

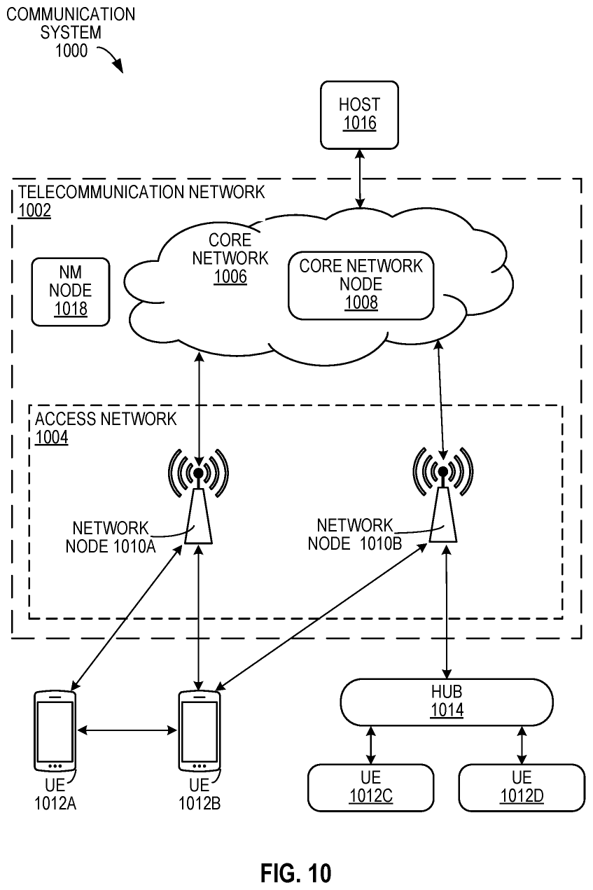

FIG. 10 shows an example of a communication system 1000 in accordance with some embodiments. In this example, the communication system 1000 includes a telecommunication network 802 that includes an access network 1004, such as a RAN, and a core network 1006, which includes one or more core network nodes 1008. In some embodiments, telecommunication network 802 can also include one or more Network Management (NM) nodes 1018, which can be part of an operation support system (OSS) or a business support system (BSS). The NM nodes can monitor operations of other nodes in access network 1004 and core network 1006.

Access network 1004 includes one or more access network nodes, such as network nodes 1010a and 1010b (one or more of which may be generally referred to as network nodes 1010), or any other similar 3GPP access node or non-3GPP access point. The network nodes 1010 facilitate direct or indirect connection of UEs, such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub-that is, a hub whose primary function is to route communications to/from the UEs from/to the network node 1010b. In other embodiments, the hub 1014 may be a non-dedicated hub-that is, a device which is capable of operating to route communications between the UEs and network node 1010b, but which is additionally capable of operating as a communication start and/or end point for certain data channels.

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

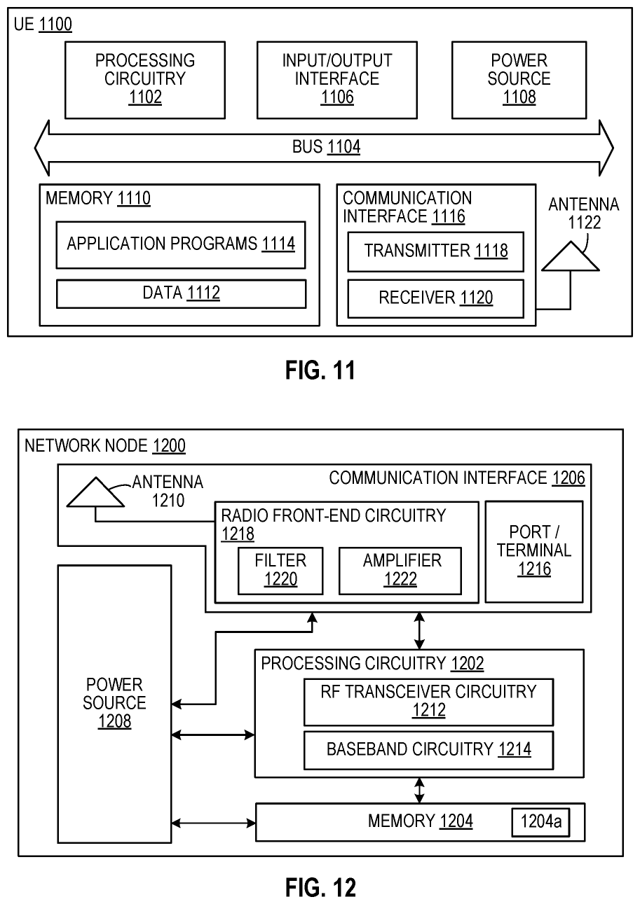

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Network Management (NM) nodes, Operations Support System (OSS) nodes, Business Support System (BSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions (collectively denoted computer program product 1204a) capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

As a specific example, network node 1200 can be configured to perform various operations attributed to a first network node or to a tracking node in the above descriptions of FIGS. 8-9.

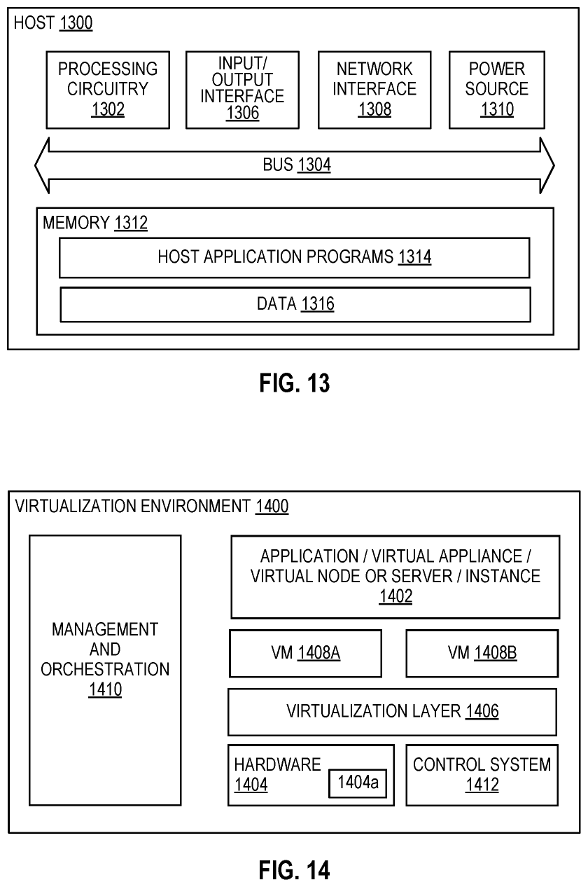

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

As a specific example, host 1300 can be configured to perform the operations attributed to a tracking node in the above descriptions of FIGS. 8-9.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment 1400 to implement some of the features, functions, and/or benefits of some of the embodiments disclosed herein. As a specific example, the first network node and/or the tracking node mentioned above in the descriptions of FIGS. 8-9 can be implemented as virtual nodes 1402 in virtualization environment 1400.

Hardware 1404 includes processing circuitry, memory that stores software and/or instructions (collectively denoted computer program product 1404a) executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g., such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, etc., such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1.-38. (canceled)

39. A method for a first network node configured to serve one or more cells in a radio access network (RAN), the method comprising:
detecting a neighbor cell for which the first network node does not store a configuration;
obtaining, from a tracking node, an indication of one or more second network nodes that store the configuration for the neighbor cell; and
obtaining the configuration for the neighbor cell from one of the indicated second network nodes.

40. The method of claim 39, further comprising:
storing the obtained configuration; and
sending, to the tracking node, a cell configuration registration indicating that the first network node stores the configuration for the neighbor cell.

41. The method of claim 40, further comprising:
after sending the cell configuration registration, receiving from a third network node a request for the configuration for the neighbor cell; and
sending the configuration for the neighbor cell to the third network node.

42. The method of claim 40, further comprising:
after sending the cell configuration registration, receiving from the tracking node an indication that the configuration for the neighbor cell has been updated;
obtaining an updated configuration for the neighbor cell from one of the indicated second network nodes; and
storing the updated configuration.

43. The method of claim 39, wherein obtaining the indication of the one or more second network nodes comprises:
after detecting the neighbor cell, sending to the tracking node a request for a list of network nodes that store the configuration for the neighbor cell; and
receiving the indication in response to the request.

44. The method of claim 43, wherein one or more of the following applies:
the tracking node does not serve any cells in the RAN; and
the tracking node does not store configurations for any cells in the RAN.

45. The method of claim 39, wherein the tracking node is a network node that serves one or more cells in the RAN, and wherein the one or more cells served by the tracking node do not include the neighbor cell.

46. The method of claim 45, wherein the tracking node is one of the second network nodes and obtaining the indication comprises:
before detecting the neighbor cell, receiving from the tracking node a cell configuration registration indicating that the tracking node stores the configuration for the neighbor cell; and
storing the received cell configuration registration.

47. The method of claim 46, wherein obtaining the configuration for the neighbor cell comprises:
based on the stored cell configuration registration, querying the tracking node for the configuration for the neighbor cell; and
receiving the configuration for the neighbor cell from the tracking node in response to the query.

48. The method of claim 45, wherein obtaining the configuration for the neighbor cell comprises:
sending a first query to a first one of the second network nodes for the configuration for the neighbor cell;
based on receiving no response to the first query, sending a second query to a second one of the second network nodes for the configuration for the neighbor cell; and
receiving the configuration for the neighbor cell from the second one of the second network nodes in response to the second query.

49. A method for a tracking node configured to track cell configurations for cells of a radio access network (RAN), the method comprising:
receiving, from a first network node, a cell configuration registration indicating that the first network node stores a configuration for a first cell in the RAN;
registering an association between the first network node and the first cell in accordance with the cell configuration registration;
subsequently receiving, from a second network node, a request for a list of network nodes that store the configuration for the first cell; and
based on the registered association, sending to the second network node an indication that the first network node stores the configuration for the first cell.

50. The method of claim 49, further comprising:
receiving, from a third network node, a further cell configuration registration indicating that the third network node stores the configuration for the first cell; and
registering an association between the third network node and the first cell in accordance with the cell configuration registration,
wherein based on the registered associations, the indication also indicates that the third network node stores the configuration for the first cell.

51. The method of claim 50, wherein the first network node serves the first cell, and the method further comprises:
receiving, from the first network node, an indication that the configuration for the first cell has been updated; and
sending, to the third network node, an indication that the configuration for the first cell has been updated.

52. The method of claim 49, wherein the tracking node stores, for each of a plurality of cells in the RAN, an indication of one or network nodes in the RAN that store a configuration for that cell.

53. The method of claim 52, wherein one or more of the following applies:
the tracking node does not serve any cells in the RAN; and
the tracking node does not store configurations for any cells in the RAN.

54. The method of claim 49, wherein:
the tracking node is a network node that serves a second cell in the RAN; and
the method further comprises sending, to the first network node and to the second network node, a cell configuration registration indicating that the tracking node stores a configuration for the second cell.

55. The method of claim 54, further comprising:
after sending the cell configuration registration, receiving from the second network node a query for the configuration for the second cell; and
sending the configuration for the second cell to the second network node in response to the query.

56. The method of claim 54, further comprising, after updating the configuration for the second cell, sending to the first network node and to the second network node an indication that the configuration for the second cell has been updated.

57. The method of claim 54, further comprising:
detecting a neighbor cell, for which the tracking node does not store a configuration;
sending queries to one or more other network nodes for a configuration for the neighbor cell; and
receiving the configuration for the neighbor cell in response to one of the queries.

58. The method of claim 57, wherein the neighbor cell is the first cell, a query is sent to the first network node based on the registered association, and the configuration is received from the first network node.

59. The method of claim 57, wherein:
the neighbor cell is a cell other than the first cell;
sending queries to one or more other network nodes comprises:
sending a first query to the first network node for the configuration for the neighbor cell, and
based on receiving no response to the first query, sending a second query to the second network node for the configuration for the neighbor cell; and
the configuration is received from the second network node in response to the second query.

60. A first network node configured to serve one or more cells in a radio access network (RAN), the first network node comprising:
communication interface circuitry configured to communicate with one or more tracking nodes and with user equipment (UEs) via the one or more cells; and
processing circuitry operably coupled to the communication interface circuitry, wherein the processing circuitry and interface circuitry are configured to:
detect a neighbor cell for which the first network node does not store a configuration;
obtain, from the tracking node, an indication of one or more second network nodes that store the configuration for the neighbor cell; and
obtain the configuration for the neighbor cell from one of the indicated second network nodes.

61. A tracking node configured to track cell configurations for cells of a radio access network (RAN), the tracking node comprising:
communication interface circuitry configured to communicate with one or more other network nodes; and
processing circuitry operably coupled to the communication interface circuitry, wherein the processing circuitry and interface circuitry are configured to:
receive, from a first network node, a cell configuration registration indicating that the first network node stores a configuration for a first cell in the RAN;
register an association between the first network node and the first cell in accordance with the cell configuration registration;
subsequently receive, from a second network node, a request for a list of network nodes that store the configuration for the first cell; and
based on the registered association, send to the second network node an indication that the first network node stores the configuration for the first cell.
